(19) United States
(12) Patent Application Publication
(10) Pub. No.: US 2009/0066039 A1
(43) Pub. Date: Mar. 12, 2009

(54) Tool-Carrier Chuck for Fitting to a Rotating Machine, Particulary of the "Impact Wrench" Type

(75) Inventor: Yves Cachod, Levier (FR)

Correspondence Address: OLIFF & BERRIDGE, PLC, P.O. BOX 320850, ALEXANDRIA, VA, 22320-4850, US

(73) Assignee: Etablissements Amyot S.A., Pontarlier (FR)

(21) Appl. No.: 11/918,615

(22) PCT Filed: May 24, 2006
(86) PCT No.: PCT/FR2006/001190

§ 371 Date: Dec. 11, 2007

(30) Foreign Application Priority Data
May 27, 2005 (FR) 0505389

(51) Int. Cl. B23B 31/12

(52) U.S. Cl. 279/60

(57) ABSTRACT

A chuck includes: a body attached to a rotating machine, carrying jaws; a peripheral nut fixedly attached to the body rotatably in a clamping direction; a ring that can be moved about the nut according to a limited angular amplitude, and having a considerable weight; and a spring connecting the nut and the ring. The nut includes a tooth interacting with a tooth of the ring to operate the ring in the clamping direction. When the body rotates in an unclamping direction, the ring, due to its inertia, does not follow the rotary movement of the nut. Then, when the machine stops and under the effect of the spring, impacts the tooth of the nut causing the jaws to clamp.

The present invention relates to a tool-carrier chuck for fitting to a rotating machine, particularly of the “impact wrench” type.

The purpose of mounting a chuck on the shaft of a rotating machine is to achieve the attachment of a tool, such as a bit if it is a drilling machine. The tool is usually attached to the chuck by means of three jaws converging towards the front, operated and guided by various means arranged in the chuck, so that the axial forward movement of the jaws results in the latter moving together in order to clamp the tool, while the rearward movement of the jaws is accompanied by an unclamping of the tool.

A chuck of the aforementioned type is usually fitted with a central part that has first a rear portion designed to be attached to a rotating machine and on which a rear ring is mounted, and secondly a front portion with which the jaws are associated and which is surrounded by a clamping ring.

The object of the rear ring and the clamping ring is to allow a user to actuate the chuck, by holding the rear ring and rotating the clamping ring. Consequently, the jaws have an internally or externally threaded portion that can be rotated either by a thread of the central part, the latter being actuated by the ring, or by a peripheral nut that is operated by the clamping ring.

Certain specific rotating machines, called “impact wrenches”, have the particular feature of rotating their spindle by a system generating radial impacts on the spindle. Such an effect makes it possible to obtain very high clamping and unclamping powers. Usually, the screw sockets and other end-pieces are mounted directly or with the aid of adapters onto the square spindle of the machine.

Now, for certain applications, it is desirable to fit the spindle of the “impact wrench” machine with a chuck to which the end-piece forming a tool is attached. But on this type of machine, a chuck without a conventional wrench, even fitted with a locking system, opens immediately if a left-hand rotation is used. This phenomenon is directly associated with the radial impacts that the machine generates.

The object of the invention is therefore to provide a chuck of the aforementioned type capable of offering the usual functionalities of a chuck, on this type of machine, and of not sustaining any unclamping irrespective of the direction of rotation.

Consequently, the invention relates to a tool-carrier chuck for fitting to a rotating machine, particularly of the “impact wrench” type, comprising:
a central part having an axis and comprising a rear portion designed to be attached to a drive shaft of the rotating machine and a front portion with which jaws are associated, the said jaws being able to be moved relative to the central part between a position of clamping of the tool and an unclamped position;
a rotating part which, placed about the central part and associated with the jaws, is designed to achieve the movement of the jaws in order to clamp or unclamp the tool, the said rotating part, during the period of operation, being fixedly attached in rotation to the central part when the latter rotates in a first direction, corresponding to the clamping direction;
a ring mounted about the rotating part for the purpose of operating the said rotating part.

The invention is more particularly characterized:
in that the ring is mounted about the rotating part rotatably according to a limited angular amplitude;
in that the rotating part comprises at least one tooth extending substantially radially outwards, designed to interact with a tooth protruding from the ring substantially radially inwards, in order to be able to rotate the ring in the first direction;
and in that elastic means are placed between the rotating part and the ring, the ring having a sufficiently large moment of inertia relative to the axis of the central part that, when the central part rotates in a second direction, corresponding to the unclamping direction, the ring does not initially follow the rotary movement in the second direction begun by the rotating part, thus causing the tension or compression of these elastic means then, under the effect of the return force of the elastic means, the tooth of the ring impacts the tooth of the rotating part causing the jaws to clamp.

Thus, when the central part rotates in the first direction (the clamping direction, usually to the right), the machine exerts on the chuck radial impacts at a given frequency towards the right. The rotating part and the ring are already in contact in the direction of clamping the chuck. The inertia of the ring therefore directly accentuates the chuck clamping effect.

Conversely, when the central part rotates in the second direction (the unclamping direction, usually to the left), the machine exerts on the chuck radial impacts at a given frequency towards the left. Because of its inertia, the ring tends not to follow the rotary movement thus generated. Consequently, the elastic means that connect the ring to the rotating part are placed in tension, while the angle of relative clearance between these two parts is reduced. Between two impacts generated by the machine, the elastic means thus stretched return to their rest position and return their energy to the ring which then strikes the rotating part in the clamping direction, which has the effect of retightening the jaws and preventing any inappropriate opening of the chuck.

According to a possible embodiment, the elastic means are placed between a tooth of the ring and a tooth of the rotating part and, for example, link the said teeth together.

The elastic means may comprise a spring having the shape of a portion of a circle, a first end of which is attached to a tooth of the ring and a second end of which is attached to a tooth of the rotating part.

Provision may be made for the ring and the rotating part each to have three teeth substantially equally distributed along their inner face, respectively outer face, the ring being mounted about the rotating part so that each tooth of the ring is placed between two teeth of the rotating part.

In this case, the second end of the spring may be attached to the tooth of the rotating part situated immediately downstream of the tooth of the ring to which the first end of the spring is attached, relative to the first direction of rotation.

The teeth of the ring and of the rotating part may each have a substantially flat and radial face forming an abutment surface, the said faces being designed to interact.

According to a possible embodiment, the ring has a weight of between 5 and 20% of the total weight of the chuck, even between 5 and 15%, even yet between 7 and 12%.

Provision can be made for the tooth of the rotating part to be formed by the interruption of a circumferential recess made in the said rotating part.

According to a first embodiment, the jaws are guided in translation in housings made in the central part forming a body, the said jaws converging towards the front and having a thread on their outer face, and in that the rotating part consists of a nut having an internal thread interacting with the thread of the jaws.

According to a second embodiment, the jaws are guided in translation in housings made in the rotating part forming a body, the jaws converging towards the front and having a thread on their inner face, the front portion of the central part being threaded and interacting with the thread of the jaws.

As a non-limiting example, a possible embodiment of the invention will now be described with reference to the appended figures:

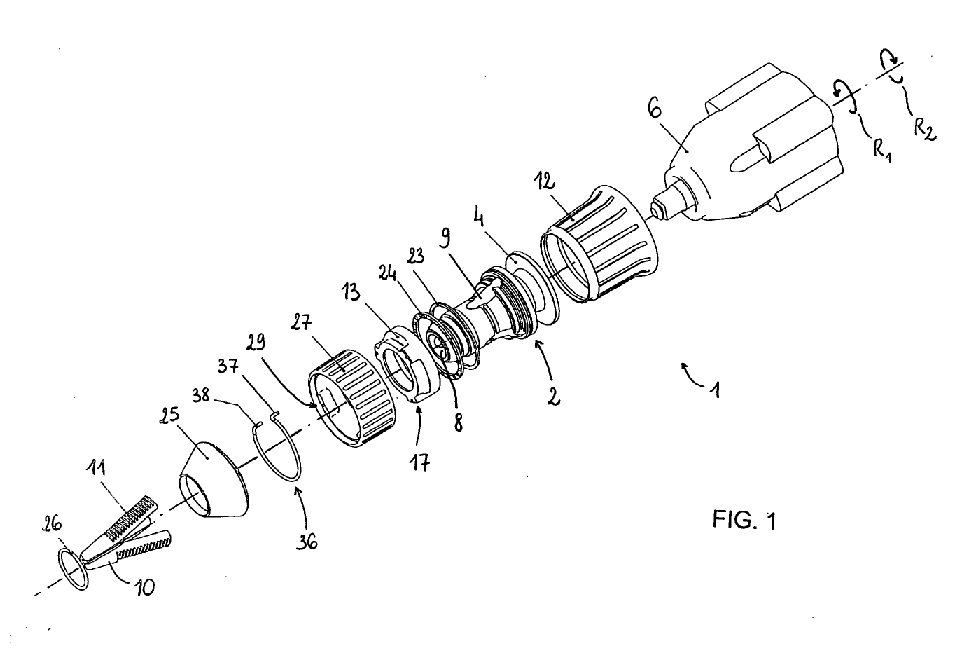

FIG. 1 is an exploded view in perspective of the chuck according to the invention;

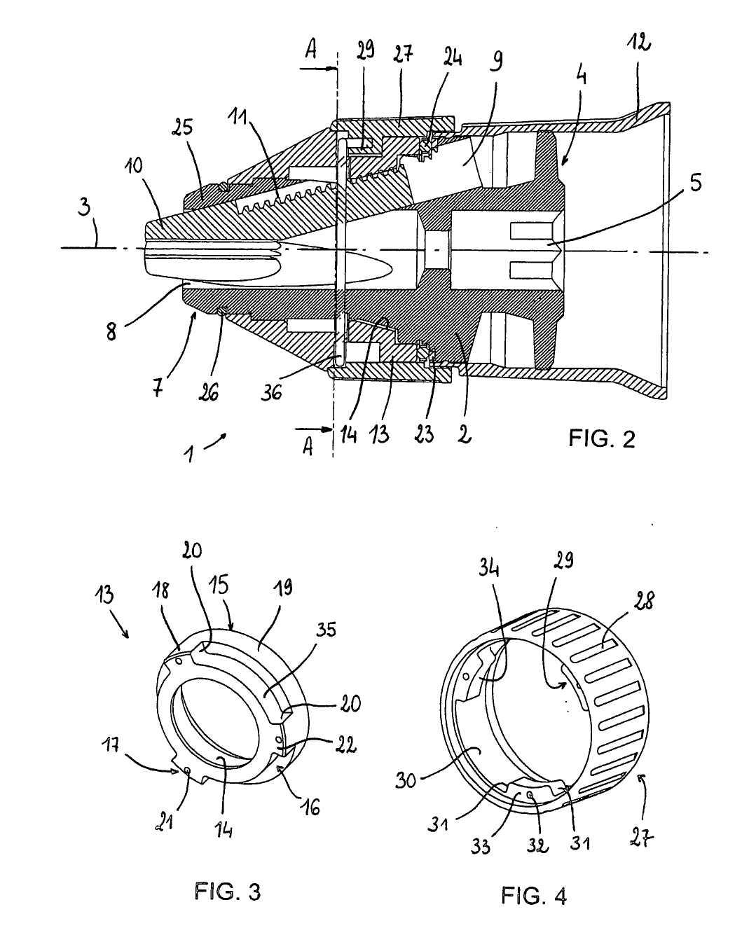

FIG. 2 is a view thereof in longitudinal section;

FIG. 3 is a view in perspective of the nut;

FIG. 4 is a view in perspective of the ring;

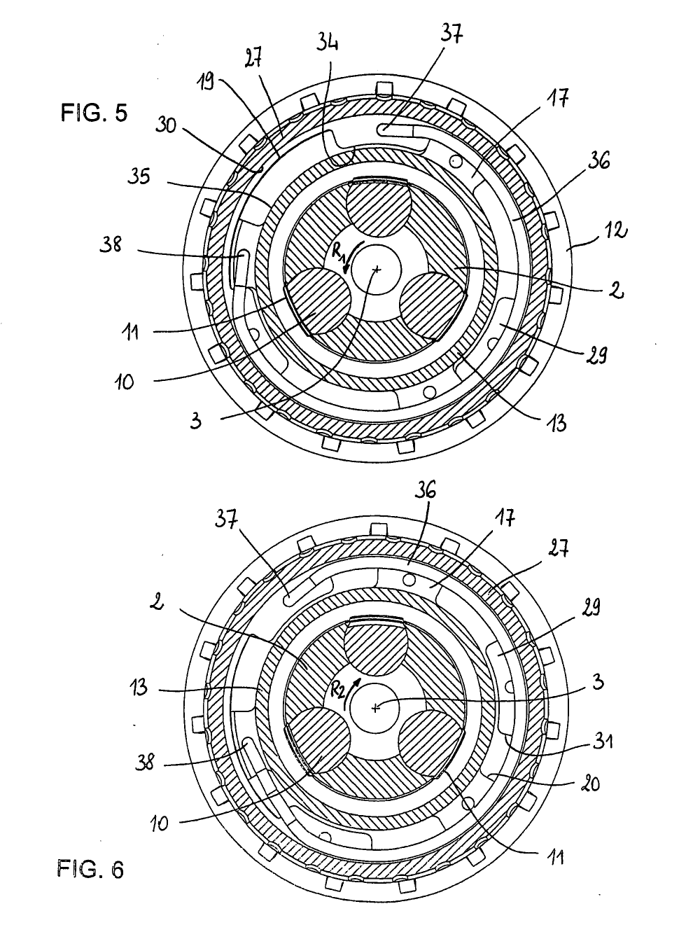

FIGS. 5 and 6 are views in section along the line AA of FIG. 2, when the central part turns to the right, respectively to the left.

The chuck 1 comprises a central part here forming a generally cylinder-shaped body 2 and having the axis 3. The rear portion 4 of the body 2 comprises an orifice 5 designed to allow the insertion of a spindle 6 of a rotating machine such as a drill. In the embodiment shown, the spindle 6 is of square section. The front portion 7 of the body 2 comprises a longitudinal bore 8 into which a tool such as a bit is intended to be inserted, and three housings 9 converging towards the front, each receiving a jaw 10 and allowing its guidance in translation. The jaws 10 have an external thread 11.

The chuck 1 also comprises a substantially cylindrical rear ring 12 engaged about the rear portion 4 of the body 2 in a substantially coaxial manner, and fixedly attached to the latter by any appropriate means (for example by a system of flats and the engagement of a flange in an annular groove).

A nut 13 is engaged about the jaws 10, substantially coaxial with the body 2. The nut 13 has an internal thread 14 interacting with the external thread 11 of the jaws 10, to make it possible to move the jaws 10 towards the clamped or unclamped position depending on the direction of rotation of the nut 13.

As illustrated in FIG. 3, the nut 13 is substantially cylindrical, of short length relative to its diameter and to the length of the body 2. The nut 13 comprises a crown-shaped rear portion 15 and a front portion having three circumferential recesses 16 spaced apart from one another. In this way three teeth 17 are defined, extending substantially radially outwards from the nut 13, the free end 18 of the teeth 17 being situated in the extension of the rear portion 15 of the nut 13, and forming with it the outer face 19 of the nut 13. The teeth 17 are equally distributed over the periphery of the nut 13. Each tooth 17 is delimited by two radial faces 20, and covers an angle of approximately 20 to 30°. In addition, each tooth 17 comprises an orifice 21 made substantially axially from its front face 22, which is orthogonal to the axis of the nut 13.

The nut 13 is mounted in rear abutment on the body 2. In order to make it easier to rotate, a steel washer 23 and a ball cage 24 are interposed between the nut 13 and the body 2.

A metal snout 25 is mounted on the body 2 in front of the nut 13, thus making it possible to retain the nut 13 axially. The metal snout 25 is itself immobilized axially forwards by a snap ring 26 engaged in a groove of the front portion 7 of the body 2.

The chuck 1 also comprises a ring 27 used for clamping, that is substantially cylindrical, mounted substantially coaxially about the nut 13, and immobilized in rotation rearwards by the rear ring 12 and forwards by the metal snout 25. The ring 27 has a knurling 28 on its outer face designed to make it easier for a user to manipulate.

The ring 27 comprises, in a front portion, three teeth 29 protruding from its inner face 30 substantially radially and inwards. The teeth 29 are substantially equally distributed circumferentially along the inner face 30. Each tooth 29 is delimited by two radial faces 31 and covers an angle of approximately 40 to 50°. In addition, each tooth 29 comprises an orifice 32 made substantially axially from its front face 33, which is orthogonal to the axis of the ring 27.

The ring 27 is mounted around the nut 13 so that each of its teeth 29 is placed between two teeth 17 of the nut 13. The height of the teeth 29 is such that, when the ring 27 is mounted around the nut 13, the free end 34 of a tooth 29 is situated close to, but with clearance, the bottom 35 of the corresponding recess 16. In this mounted position, the free end 18 of the teeth 17 is situated close to, but with clearance, the inner face 30 of the ring 27.

The ring 27 has a considerable moment of inertia relative to the axis 3 of the body 2, obtained by a considerable weight. As an example, the weight of the ring 27 is between 40 and 50 g for a total weight of the chuck 1 of the order of 400 g.

Finally, the chuck 1 comprises a spring 36 in the shape of a portion of a circle, covering for example an angle of between 250 and 300°. A first end 37 of the spring 36 is attached in the orifice 32 of a tooth 29 of the ring 27, and the second end 38 of the spring 36 is attached in the orifice 21 of a tooth 17 of the nut 13 situated immediately downstream relative to the clamping direction.

For the clamping or unclamping of a tool in the bore 8 of the body 2 of the chuck 1, a user holds the rear ring 12 with one hand and, with the other hand, rotates the ring 27 relative to the rear ring 12. He therefore causes the nut 13 to rotate due to the interaction between the teeth 17 and 29. Consequently, via the interaction between the external thread 11 of the jaws 10 and the internal thread 14 of the nut 13, the jaws 10 are moved in the housings 9 of the body 2. Depending on the direction of rotation of the ring 27, the jaws 10 are moved towards their clamping position, where they protrude towards the front of the chuck 1 and are closer to one another so as to keep the tool clamped between them, or towards an unclamped position, where they are retracted at least partially inside the chuck 1 and moved away from one another, the tool then being able to be removed from the chuck 1.

Reference is now made to FIGS. 5 and 6 which illustrate the relative position of the various parts forming the chuck 1 according to the direction of rotation of the rotating machine.

When the spindle 6 turns to the right, which corresponds to the clamping direction, it rotates the body 2 and the nut 13 via the jaws 10 to the right (FIG. 5, arrow R1). The downstream (relative to the direction R1) radial face 20 of each tooth 17 of the nut 13 is in contact with the upstream radial face 31 of a tooth 29 of the ring 27. Consequently, the rotation to the right of the nut 13 rotates the ring 27 to the right. In this configuration, the spring 36 is in the rest position or slightly stretched.

When the spindle 6 turns to the left, which corresponds to the unclamping direction, it rotates the body 2, and consequently the jaws 10 engaged in the housings 9 of the body 2, to the left (FIG. 6, arrow R2). By interaction between the internal thread 14 of the nut 13 and the external thread 11 of the jaws 10, the nut 13 begins a rotation to the left which cannot continue beyond a certain angle of rotation due to the progressive clamping of the jaws 10.

Since there is an angular space between the radial face 20 downstream (relative to the direction R2) of each tooth 17 of the nut 13 and the radial face 31 upstream of the corresponding tooth 29 of the ring 27, the nut 13 cannot operate the ring 27 by means of the direct interaction between the teeth. In addition, due to the considerable rotational inertia of the ring 27, the spring 36, whose second end is rotated in the direction R2 by the tooth 17 of the nut 13 to which it is attached, also does not allow a simultaneous operation of the ring 27 and the nut 13.

Since the ring 27 does not follow the rotation to the left of the nut 13, the angular space between the teeth 17, 29 that were in contact in the case of the rotation to the right (R1) increases, and the spring 36 stretches, thus storing the energy that will be used for the reclamping.

While the movement to the left of the rotating machine is stopped (operation by radial impacts), and under the effect of the return force of the spring 36, the ring 27 is rotated sharply to the left. Its teeth 29 “catch up with” the teeth 17 of the nut 13 which they hit with an impact that causes the nut 13 to rotate to the left relative to the body 2, and therefore causes the jaws 10 to reclamp. The parts forming the chuck 1 are then again in the position of FIG. 5.

Those skilled in the art will understand that the weight of the ring 27 (or more generally its moment of inertia relative to the axis 3 of the body 2), the stiffness of the spring 36 and the friction between the ring 27 and the nut 13 must be carefully chosen to make it possible to cause a sufficient rotational retarding of the ring 27 relative to the nut 13 and a sufficient impact of the teeth 29 on the teeth 17 to make it possible to reclamp the jaws 10.

It goes without saying that the invention is not limited to the embodiment described as an example hereinabove, but that, on the contrary, it embraces all the variant embodiments.

As a variant, the elastic means could for example be formed of a compressible foam placed between two adjacent teeth of the ring and of the rotating part.

1. Tool-carrier chuck for fitting to a rotating machine, particularly of the “impact wrench” type, comprising:
a central part having an axis Hand comprising a rear portion designed to be attached to a drive shaft of the rotating machine and a front portion with which jaws are associated, the said jaws being able to be moved relative to the central part between a position of clamping of the tool and an unclamped position;
a rotating part which, placed about the central part and associated with the jaws, is designed to achieve the movement of the jaws in order to clamp or unclamp the tool, the said rotating part during the period of operation, being fixedly attached in rotation to the central part when the latter rotates in a first direction, corresponding to the clamping direction;
a ring mounted about the rotating part for the purpose of operating the said rotating part;
wherein:
the ring is mounted about the rotating part rotatably according to a limited angular amplitude;
the rotating part comprises at least one tooth extending substantially radially outwards, designed to interact with a tooth protruding from the ring substantially radially inwards, in order to be able to rotate the ring in the first direction;
and elastic means are placed between the rotating part and the ring, the ring having a sufficiently large moment of inertia relative to the axis of the central part that, when the central part rotates in a second directions, corresponding to the unclamping direction, the ring does not initially follow the rotary movement in the second direction begun by the rotating part, thus causing the tension or compression of these elastic means then, under the effect of the return force of the elastic means, the tooth of the ring impacts the tooth of the rotating part causing the jaws to clamp.

2. Chuck according to claim 1, wherein the elastic means are placed between a tooth of the ring and a tooth of the rotating part.

3. Chuck according to claim 1, wherein the elastic means connect a tooth of the ring and a tooth of the rotating part.

4. Chuck according to claim 1, wherein the elastic means comprise a spring having the shape of a portion of a circle, a first end of which is attached to a tooth of the ring and a second end of which is attached to a tooth of the rotating part.

5. Chuck according to claim 1, wherein the ring and the rotating part each have three teeth substantially equally distributed along their inner face, respectively outer face, the ring being mounted about the rotating part so that each tooth of the ring is placed between two teeth of the rotating part.

6. Chuck according to claim 4, wherein the second end of the spring is attached to the tooth of the rotating part situated immediately downstream of the tooth of the ring to which the first end of the spring is attached, relative to the first direction of rotations.

7. Chuck according to claim 1, wherein the teeth of the ring and of the rotating part each have a substantially flat and radial face forming an abutment surface, the said faces being designed to interact.

8. Chuck according to claim 1, wherein the ring has a weight of between 5 and 20% of the total weight of the chuck.

9. Chuck according to claim 1, wherein the tooth of the rotating part is formed by the interruption of a circumferential recess made in the said rotating part.

10. Chuck according to claim 1, wherein the jaws are guided in translation in housings made in the central part forming a body, the said jaws converging towards the front and having a thread on their outer face, and in that the rotating part consists of a nut having an internal thread interacting with the thread of the jaws.

11. Chuck according to claim 1, wherein the jaws are guided in translation in housings made in the rotating part forming a body, the jaws converging towards the front and having a thread on their inner face, the front portion of the central part being threaded and interacting with the thread of the jaws.
